(19) United States
(12) Patent Application Publication
(10) Pub. No.: US 2026/0275546 A1
(43) Pub. Date: Sep. 17, 2026

(54) METHOD FOR PRODUCING HYDROGEN AND APPARATUS FOR PRODUCING HYDROGEN

(71) Applicant: Helander Holding Oy, Turku (FI)

(72) Inventor: Sami TUOMINEN, Turku (FI)

(73) Assignee: Helander Holding Oy, Turku (FI)

(21) Appl. No.: 19/162,177

(22) PCT Filed: Mar. 5, 2024
(86) PCT No.: PCT/FI2024/050084

§ 371 Date: Sep. 4, 2025

(30) Foreign Application Priority Data
Mar. 6, 2023 (FI) 20235257

(51) Int. Cl. C25B 11/043; C25B 1/04; C25B 9/23; C25B 11/046; C25B 15/08

(52) U.S. Cl. CPC C25B 11/043; C25B 1/04; C25B 9/23; C25B 11/046; C25B 15/08

(57) ABSTRACT

A method for producing hydrogen comprises providing water and a gaseous substance, the gaseous substance comprising hydrogen atoms and carbon atoms, producing a mixture comprising the water and bubbles comprising the gaseous substance, decreasing a diameter of the bubbles comprising the gaseous substance, and producing gaseous hydrogen by decomposing the gaseous substance in the bubbles having the decreased diameter. An apparatus is configured for producing hydrogen gas.

### FIELD OF THE INVENTION

The present invention relates to a method for producing hydrogen and more particularly to a method according to the preamble of claim 1.

The present invention further relates to apparatus for producing hydrogen and more particularly to apparatus according to the preamble of claim 12.

### BACKGROUND OF THE INVENTION

In the light of climate change mitigation and the resulting urge to decrease greenhouse gas (GHG) emissions, hydrogen is seen as an important component for future energy systems because its energetic use does not lead to direct CO2 emissions. Additionally, hydrogen as an energy carrier shows a broad range of existing and potential use cases, e.g., within the electricity, transport, industrial, and heating sector. It can be directly used as hydrogen or alternatively used to synthesize hydrocarbons used as fuels similar to natural gas or diesel/gasoline, within existing supply chains and applications.

The most prominent technological concepts are the hydrogen production from natural gas through steam methane reforming (SMR) combined with CO2 capture and storage (CCS) and water electrolysis powered by electricity from renewable sources of energy.

In the prior art different configurations of methane decomposition processes have been studied but a limited number of these processes have been brought to the market.

One of the problems associated with the prior art is a complexity and a low efficiency of the decomposition process.

### BRIEF DESCRIPTION OF THE INVENTION

An object of the present invention is to provide a method for producing hydrogen and apparatus for producing hydrogen so as to solve or at least alleviate the prior art disadvantages.

The objects of the invention are achieved by a method which is characterized by what is stated in the independent claim 1. The objects of the invention are achieved by apparatus which is characterized by what is stated in the independent claim 12.

The preferred embodiments of the invention are disclosed in the dependent claims.

The invention is based on the idea of providing method for producing hydrogen. The method comprises providing water and a gaseous substance, the gaseous substance comprises hydrogen atoms and carbon atoms, producing a mixture comprising the water and bubbles comprising the gaseous substance, decreasing diameter of the bubbles comprising the gaseous substance, and producing gaseous hydrogen by decomposing the gaseous substance in the bubbles having the decreased diameter.

According to the present invention the gaseous substance comprises molecules comprising hydrogen atoms and carbon atoms.

According to the present invention the gaseous substance comprises molecules consisting of hydrogen atoms and carbon atoms.

According to the present invention the gaseous substance consists of molecules consisting of hydrogen atoms and carbon atoms.

The gaseous substance may comprise for instance propane, butane, propylene, butadiene, butylene, isobutylene, and mixtures thereof.

According to the present invention the gaseous substance comprises methane.

According to the present invention the gaseous substance consists of methane.

According to the present invention the gaseous substance being methane.

Methane is a chemical compound with the chemical formula CH₄ Natural gas comprises methane and typically some impurities and natural gas is widely available.

Methane may be produced also from anaerobic digestion of biomass.

According to the present invention the step of decreasing diameter of the bubbles is carried out with a nano bubble device.

According to the present invention the step of decreasing diameter of the bubbles is carried out with a nano bubble device providing bubbles having a diameter less than 180 nm.

According to the present invention the step of decreasing diameter of the bubbles is carried out with a nano bubble device comprising any one of the following: pressurized dissolution device, a rotational flow device, a turbulent static mixer, an ejector nozzle and an ultrasonic device and venturi device.

According to the present invention the step of decreasing diameter of the bubbles is carried out with a nano bubble device comprising any one of the following: pressurized dissolution device, a rotational flow device, a turbulent static mixer, an ejector nozzle and an ultrasonic device or venturi device, and the nano bubble device providing bubbles having a diameter less than 180 nm.

Nanobubbles increases an efficiency of the method.

According to the present invention the nano bubble device providing bubbles having a diameter between 30 nm and 180 nm.

According to the present invention the nano bubble device providing bubbles having a diameter between 50 nm and 180 nm.

It is difficult to produce bubbles having a diameter less than 50 nm.

According to the present invention the method comprises decomposing the gaseous substance is carried out with an electrolytic cell.

According to the present invention the method comprises decomposing the gaseous substance to hydrogen atoms and carbon atoms, and decomposing the gaseous substance is carried out with an electrolytic cell.

The electrolytic cell is an efficient device to carry out decomposing.

According to the present invention the method comprises decomposing a part of the water.

According to the present invention the method comprises decomposing a part of the water with the electrolytic cell.

Oxygen from the decomposed water compose carbon dioxide or mono-oxide with the carbon from decomposed gaseous substance.

According to the present invention the method comprises obtaining hydrogen gas from step of decomposing the gaseous substance, and conducting the obtained hydrogen gas into a fuel cell, and converting the hydrogen gas into energy with the fuel cell.

According to the present invention the method comprises obtaining hydrogen gas from step of decomposing the gaseous substance, and conducting the obtained hydrogen gas to an engine.

According to the present invention the method comprises obtaining hydrogen gas from step of decomposing the gaseous substance.

Hydrogen as an energy carrier shows a broad range of existing and potential use cases, e.g., within the electricity, transport, industrial, and heating sector.

According to the present invention the method comprises obtaining oxygen from the step of decomposing water and composing at least one of carbon monoxide and carbon dioxide from the carbon of the decomposed gaseous substance and oxygen obtained from the decomposed water.

According to the present invention in the step of providing water, the water being purified water.

According to the present invention the method comprises a step of purifying water.

Purified water increases longevity of device components which are used for carrying out the method.

According to the present invention the step of decomposing the gaseous substance is carried out with an anode element and a cathode element, and the method comprises providing the anode element and the cathode element with electric energy

According to the present invention the step of decomposing the gaseous substance is carried out with an anode element and a cathode element, and the method comprises providing the anode element and the cathode element with electric energy, and the anode element comprises platinum and the cathode element comprises stainless steel.

According to the present invention the step of decomposing the gaseous substance is carried out with an anode element and a cathode element, and the method comprises providing the anode element and the cathode element with electric energy, and the anode element and the cathode element comprises diamond.

According to the present invention the step of decomposing the gaseous substance is carried out with an anode element and a cathode element, and the method comprises providing the anode element and the cathode element with electric energy, and the anode element and the cathode element comprises black diamond.

According to the present invention the step of decomposing the gaseous is carried out with an anode element and a cathode element, and the method comprises providing the anode element and the cathode element with electric energy, and the anode element comprises an ion exchange film and the cathode element comprises stainless steel.

According to the present invention the ion exchange film of the anode element may partially homogeneous membrane.

The partially homogenous membrane remains active even it is contact with air.

According to the present invention the ion exchange film of the anode element may be a heterogenous membrane or homogeneous membrane.

Diamond anode does not corrode but diamonds are expensive.

According to the present invention the method comprises providing a catalyst.

According to the present invention the method comprises providing a catalyst, and the bubbles comprise the gaseous substance and the catalyst in the step of producing a mixture.

According to the present invention the method comprises providing a catalyst comprising metallic nanoparticles, in the step of producing a mixture the bubbles comprise the gaseous substance and the catalyst.

According to the present invention the method comprises providing a catalyst, and the bubbles comprise the gaseous substance and the catalyst in the step of producing a mixture, and the catalyst consists of nanoparticles.

According to the present invention the method comprises providing the gaseous substance with a catalyst comprising metallic nanoparticles.

According to the present invention the method comprises a step of providing the gaseous substance with a catalyst, the catalyst comprises metallic nanoparticles, and the step of providing the gaseous substance with a catalyst is carried out before the step of producing a mixture.

According to the present invention the method is carried out with any embodiment apparatus disclosed below.

The present invention further relates to apparatus for producing hydrogen. The apparatus comprises a mixing vessel arranged to receive a liquid substance and a gaseous substance and arranged to produce a mixture comprising the liquid substance and bubbles comprising the gaseous substance, a nano bubble device arranged to decrease a diameter of bubbles comprising the gaseous substance, and a decomposing device arranged to decompose bubbles having the decreased diameter.

According to the present invention the liquid substance being water.

According to the present invention the decomposing device may comprises an electrolytic cell.

According to the present invention the mixing vessel comprises a first liquid inlet arranged to receive the liquid into the mixing vessel and a second inlet arranged to receive the gaseous substance into the mixing vessel.

According to the present invention the mixing vessel comprises a first liquid inlet arranged to receive the liquid into the mixing vessel and a second inlet arranged to receive the gaseous substance into the mixing vessel, and the mixing vessel comprises the nano bubble device.

According to the present invention the nano bubble device comprising any one of the following: pressurized dissolution device, a rotational flow device, a turbulent static mixer, an ejector nozzle and an ultrasonic device and a venturi device.

According to the present invention the decomposing device comprises an anode element and a cathode element.

According to the present invention the decomposing device comprises an anode element and a cathode element, and the anode element comprises platinum and the cathode element comprises stainless steel.

According to the present invention the decomposing device comprises an anode element and a cathode element and the anode element and the cathode element comprises diamond.

According to the present invention the decomposing device comprises an anode element and a cathode element, and the anode element and the cathode element comprises black diamond.

According to the present invention the decomposing device comprises an anode element and a cathode element, the anode element comprises an ion exchange film and the cathode element comprises stainless steel.

According to the present invention the ion exchange film of the anode element may partially homogeneous membrane.

The partially homogenous membrane remains active even it is contact with air.

According to the present invention the ion exchange film of the anode element may be a heterogenous membrane or homogeneous membrane.

Diamond anode does not corrode but diamonds are expensive.

According to the present invention the decomposing device is arranged to receive the mixture comprising gaseous substance and the liquid substance from the nano bubble device.

An advantage of the invention is that the invention provides an efficient method and apparatus for producing gaseous hydrogen from a gaseous substance comprising hydrogen and carbon.

### BRIEF DESCRIPTION OF THE DRAWINGS

The invention is described in detail by means of specific embodiments with reference to the enclosed drawings, in which:

FIG. 1 shows principles of the method according to the present invention; and

FIG. 2 shows schematically one embodiment of apparatus for producing hydrogen according to the present invention; and

FIG. 3 shows schematically one embodiment of apparatus for producing hydrogen according to the present invention.

### DETAILED DESCRIPTION OF THE INVENTION

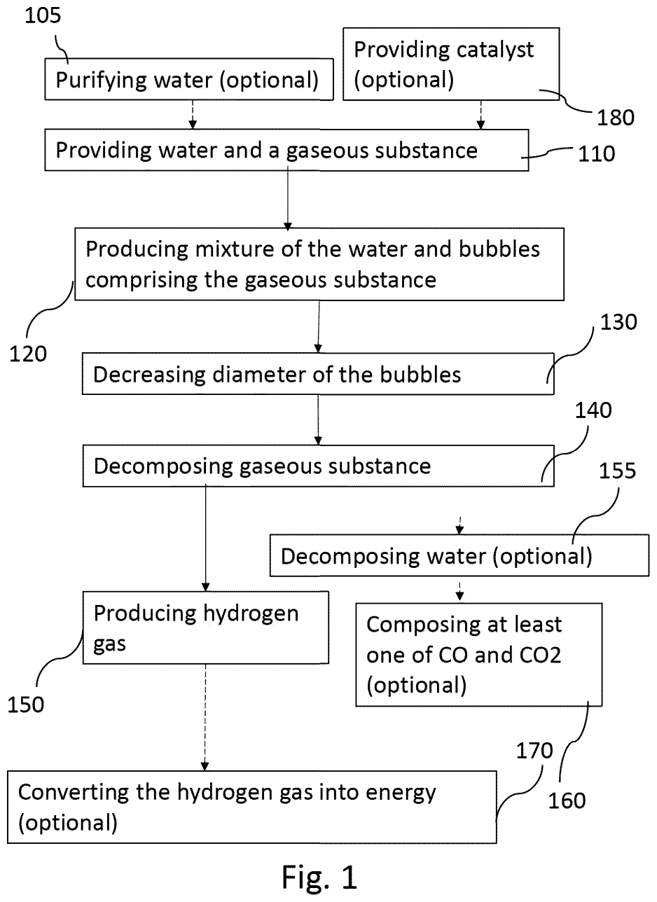

FIG. 1 discloses a method for producing hydrogen. The method comprises in the step 110 providing water and a gaseous substance, the gaseous substance comprises hydrogen atoms and carbon atoms. In the step 120, the method comprises producing a mixture comprising the water and bubbles comprising the gaseous substance. Then in the step 130 decreasing a diameter of bubbles comprising the gaseous substance. Further, in the step 140 the method comprises decomposing gaseous substance in bubbles having the decreased diameter.

The bubbles having the decreased diameter means the bubbles after the step 130 decreasing a diameter of bubbles comprising the gaseous substance.

The bubbles having the decreased diameter means the bubbles formed in the step 130 decreasing a diameter of bubbles comprising the gaseous substance.

It should be noted that decomposing gaseous substance in bubbles having the decreased diameter means that at least some of gaseous substance is decomposed.

In certain embodiments, 1-100 wt-% of gaseous substance is decomposed based on a total weight of the gaseous substance.

In certain embodiments, 20-90 wt-% of gaseous substance is decomposed based on a total weight of the gaseous substance.

Further, in the step 150 the method comprises producing hydrogen gas.

It should be noted that the above described basic principle of the present invention may be carried out or implemented in various ways in order to provide the method of the present invention. Accordingly, the present invention is not limited to any particular implementation of the present invention.

The gaseous substance comprises hydrogen atoms and carbon atoms means that the gaseous substance comprises compound which comprises one or more hydrogen atoms and one or more carbon atoms.

In certain embodiments, the gaseous substance comprises molecules comprising hydrogen atoms and carbon atoms.

In certain embodiments, the gaseous substance comprises molecules consisting of hydrogen atoms and carbon atoms.

In certain embodiments, the gaseous substance consists of molecules consisting of hydrogen atoms and carbon atoms.
the gaseous substance comprises methane; or
the gaseous substance consists of methane; or
the gaseous substance being methane.

In certain embodiments, producing a mixture comprising the water and bubbles comprising the gaseous substance is carried out by compression of the gaseous substance into the water.

In certain embodiments, the step of decreasing a diameter of the bubbles is carried out with a nano bubble device 2 comprising any one of the following: pressurized dissolution device, a rotational flow device, a turbulent static mixer, an ejector nozzle and an ultrasonic device or venturi device.

Nanobubbles may be produced with ultrasonic power.

In certain embodiments, decomposing the gaseous substance to hydrogen atoms and carbon atoms, and decomposing the gaseous substance is carried out with an electrolytic cell 35. The electrolytic cell 35 is an electrochemical cell that uses electrical energy to drive a non-spontaneous redox reaction. It is often used to decompose chemical compounds.

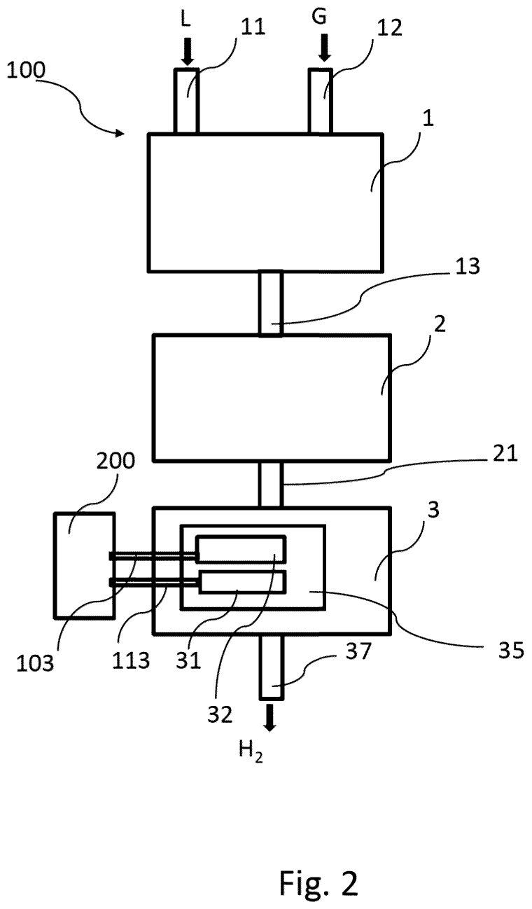

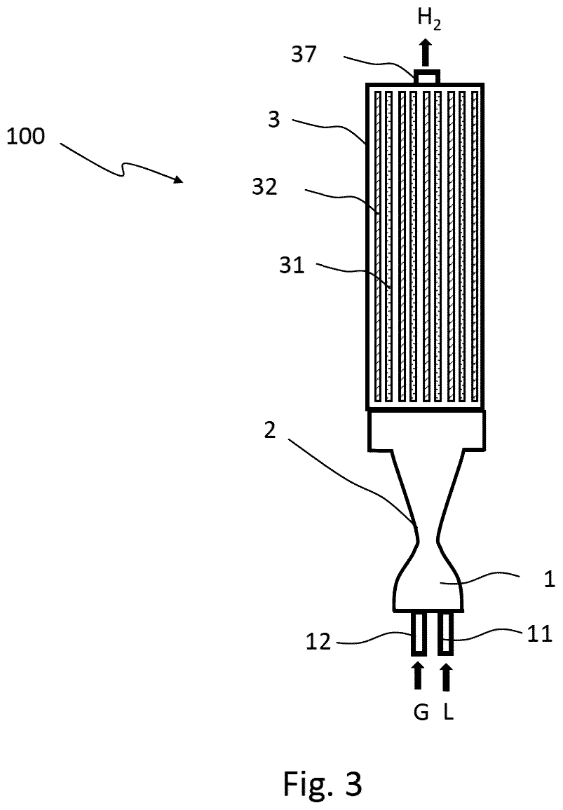

In certain embodiments, the method is carried out with a decomposing device 3 disclosed in FIG. 2 or disclosed in FIG. 3.

In certain embodiments, the water being purified water.

In certain embodiments, the method comprises a step of purifying water 105.

For instance, the water may be for purified by distillation.

In certain embodiments, the method comprises a step of decomposing a part of the water with the electrolytic cell 35.

In certain embodiments, the method comprises a step of decomposing 1-99 wt-% or 0.1-50 wt-% or 20-80 wt-% of the water based on the total weight of the water, the step of decomposing water is carried out with the electrolytic cell 35.

In certain embodiments, the method comprises a step 170 of converting the hydrogen gas into energy.

In certain embodiments, the method comprises a step 155 of decomposing water. It should be noted that all of the water is not decomposed.

In certain embodiments, the method comprises a step 160 of composing at least one of CO and CO₂.

In certain embodiments, the method comprises a step 170 of converting the hydrogen gas into energy.

In certain embodiments, Further, in the step 180 the method comprises providing a catalyst.

In certain embodiments, Further, the method comprises providing a catalyst, and the bubbles comprise the gaseous substance and the catalyst in the step of producing a mixture.

In other words, the method comprises providing the gaseous substance with a catalyst comprising metallic nanoparticles.

In certain embodiments, the catalyst comprises nanoparticles.

In certain embodiments, the catalyst comprises metallic nanoparticles.

In certain embodiments, the catalyst comprises metallic oxide nanoparticles.

In certain embodiments, the catalyst comprises Co₃O₄ nanoparticles.

In certain embodiments, the catalyst comprises Cobalt-Iron oxyhydroxides nanoparticles.

In certain embodiments, catalyst comprising metallic nanoparticles, in the step of producing a mixture the bubbles comprise the gaseous substance and the catalyst.

In certain embodiments, the step of providing the gaseous substance with a catalyst is carried out before the step of producing a mixture.

It should be noted that the bubbles having a decreased diameter comprises the catalyst,

In other words, the catalyst remains in the bubbles in the step of decreasing the diameter of the bubbles.

In certain embodiments, the method is carried out with any embodiment of apparatus 100 disclosed below.

### Example 1

Hydrogen was produced by decomposing methane in micro-bubbles having a diameter between 0.001 mm to 0.01 mm and decomposing methane in nanobubbles having a diameter less than 180 nm. Decomposing methane was carried out with electrolysis cell.

The inventor surprisingly found out that hydrogen production from nanobubbles increases hydrogen yield.

FIG. 2 shows one embodiment of apparatus 100 for producing hydrogen of the present invention.

The apparatus 100 comprises a mixing vessel 1 arranged to a receive liquid substance and a gaseous substance and arranged to produce a mixture comprising the liquid substance and bubbles comprising the gaseous substance, a nano bubble device 2 arranged to decrease a diameter of bubbles comprising the gaseous substance in the liquid substance, and an decomposing device 3 arranged to decompose bubbles comprising the gaseous substance having a decrease diameter.

In certain embodiment, the decomposing device 3 comprises an electrolytic cell 35. The electrolytic cell 35 is an electrochemical cell that uses electrical energy to drive a non-spontaneous redox reaction. It is often used to decompose chemical compounds.

In certain embodiments, the electrolytic cell 35 further comprises a first electricity inlet 113 electrically connected to the anode element 31 and a second electricity inlet 103 electrically connected to cathode element 32.

In certain embodiments, the electrolytic cell 35 further comprises a direct electric current source 200 providing an electricity energy to the first electricity inlet 113 and the second electricity inlet 103.

In certain embodiments, the first electricity inlet 113 and the second electricity inlet 103 are made of stainless steel.

In certain embodiments, the direct electric current source 200 is arranged to provide a flow of electrons towards the second electricity inlet 103.

In other words, a negative terminal of the direct electric current source 200 is electrically connected to the second electricity inlet 103.

In one embodiment, the direct electric current source 200 is arranged to provide an electric power having 10-30 voltage and current of 25-55 ampere.

In one embodiment, the direct electric current source 200 is arranged to provide an electric power having an electric potential between 10 V and 30 V and a current between 25 and 55 A.

In one embodiment, the electric potential being adjustable between 12 V and 24 V and the current being constant.

In one embodiment, the electric potential is arranged to be adjustable between 12 V and 24 V based on an amount of impurities in the water.

In certain embodiments, the step of decomposing the gaseous substance is carried out with an anode element 31 and a cathode element 32, and the method comprises providing the anode element 31 and the cathode element 32 with electric energy.

In certain embodiments, the anode element 31 comprises platinum and the cathode element 32 comprises stainless steel.

In certain embodiments, the cathode element 6 comprises one or more cathode plates 10 made of AISI304 or AISI316 stainless steel.

In certain embodiments, the anode element 31 and the cathode element 32 comprises diamond.

In certain embodiments, the anode element 31 and the cathode element 32 comprises black diamond.

Black diamonds, also referred to as ‘carbonado’, are made up of high amounts of carbon and graphite, giving them a deep and rich black colour. Black diamonds are in fact real diamonds. They contain the same chemical compounds as colourless diamonds.

In certain embodiments, the anode element 31 comprises an ion exchange film and the cathode element 32 comprises stainless steel.

The water being an electrolyte of the electrolytic cell 35.

In certain embodiments, the mixing vessel 1 being an airtight container.

In certain embodiments, the mixing vessel 1 being a pressure vessel designed to hold gases or liquids at a pressure between 1-5 atm.

In certain embodiments, the mixing vessel 1 comprises a first liquid inlet 11 arranged to receive the liquid into the mixing vessel 1 and a second inlet 1 arranged to receive the gaseous substance into the mixing vessel 1.

In certain embodiments, the nano bubble device 2 comprising any one of the following: pressurized dissolution device, a rotational flow device, a turbulent static mixer, an ejector nozzle and an ultrasonic device and a venturi device.

In certain embodiments, the nano bubble device 2 is configured to provide bubbles having a diameter less than 180 nm.

In pressurized dissolution method ultrafine bubble generation is based on the principles of Henry's Law, which relates the concentration of a gas to the partial pressure. This means that more gas can be dissolved into a solution at a higher pressure.

The principle of the ultrafine bubble generator is as follows: Via a venturi system the liquid and the gas are mixed together, in the next step in the mixing box the gas is melted into the water via pressurization. In the last step via a nozzle the water and gas is discharged. Due to drastic drop in pressure of the supersaturated liquid gas solution, the gas is expelled as fine bubbles and ultrafine bubbles in the liquid. The FIG. 3 shows one embodiment of a device of the pressurized dissolution method. Liquid is pumped into the unit under pressure. By narrowing the diameter of the pipe, the speed of the incoming liquid flow is increased, which converts most of the pump pressure into dynamic pressure, thus reducing static pressure and air being suctioned through negative pressure. After the liquid and suctioned gas become saturated with bubbles, the liquid/gas flow is sent through a wider pipe to reduce the speed of the flow, where dynamic pressure is converted back to static pressure and the process of pressurized dissolution of gas takes place. After the gas is completely dissolved into the liquid, the liquid/gas is ejected at once using atmospheric pressure, causing the liquid to become over-saturated, and massive ultra-fine nanobubbles are released.

Rotational flow is also often called Swirl Method or Spiral Flow. This fine bubble generator generates bubbles according to the Bernoulli's principle. In fluid dynamics, Bernoulli's principle states that an increase in the speed of a fluid occurs simultaneously with a decrease in pressure or a decrease in the fluid's potential energy. Centuries later, fine bubble generators are made based on this principle. In the mid-nineties, the first swirling type micro-bubbles was invented in Japan. The principle of the fine bubble generator is as follows: water is put into a cylindrical tank from the topside and made to flow in a spiral downwards. From the centre bottom of the cylinder, the gas is sucked in. The rotating water is sheared to the top of the cylinder, producing fine bubbles. However, it's generally acknowledged in the ultrafine bubble industry that the bubble concentration of the pressurized dissolution method is higher than the rotational flow.

The static mixer has its origin from mixing two liquids. Instead of mixing two liquids, there is also the possibility of mixing a liquid and a gas. This technology is based on the principle of creating a vortex and bringing into the vortex a gas very effectively. Due to the turbulent flow gas will break the vortex and the collisions between water and gas creates the nanobubbles. The benefits of the static mixers are that they have a relatively simple design, and they can treat large volumes of water at once with relative little energy compared to many of the other above nanobubble generators. Finally, they are not sensitive to clogging. The acniti Turbiti technology is a combination of the turbulent static mixer and the Ejector Nozzle.

In the ejector nozzle nanobubble generator type, liquid flow channels in the cylindrical generator are designed to shrink and stepwise enlarge. The gas is brought in under negative pressure at the most reduced pressure point and reduced to a number of nanobubbles by cavitation. In this device, the water flow is highly turbulent, and the gas is reduced to nanobubbles by cavitation. Ejector nozzles are closely related to hydrodynamic cavitation generators, with this method cavitation is generated by the flow of liquid through a simple geometry under controlled conditions. In this nanobubble generator, when the pressure falls below the vapor pressure of the liquid, the liquid flashes, generating a number of cavities. The cavities collapse when the pressure recovers. The collapse of the cavitation bubbles starts some physicochemical effects such as shock waves, shear forces and chemical reactions. Free radicals are sometimes generated by these processes.

The hammermill rotation concept is a unique concept compared to all the other nanobubble generation techniques, as it does not use a pump to generate nanobubble. Instead, it uses a motor with hammers mounted on the shaft. The motor turns at a velocity of 3400 rotations per minute in a tube. The tube fills with water from the top, and the gas injection is also from the top. The hammers on the shaft dissolve the gas and crushes the gas into nanobubble at the bottom of the unit the nanobubbles come out. The hammer rotation concept is the most energy friendly way to generate nanobubbles as it is not moving large amounts of water and doesn't need a high pressure but uses all its energy to crush the gas. The line-up of hammermill rotation nanobubble generators is called the microStar nanobubble generator.

In certain embodiments, the decomposing device 3 comprises an electrolytic cell 35.

In certain embodiments, the decomposing device 3 comprises an electrolytic cell 35 comprising an anode element 31 and a cathode element 32.

In certain embodiments, the anode element 31 comprises platinum and the cathode element 32 comprises stainless steel.

In certain embodiments, the anode element 31 and the cathode element 32 comprises diamond.

In certain embodiments, the anode element 31 and the cathode element 32 comprises black diamond.

In certain embodiments, the anode element 31 comprises an ion exchange film and the cathode element 32 comprises stainless steel.

In certain embodiments, the decomposing device 3 is arranged to receive the mixture comprising gaseous substance and the liquid substance from the nano bubble device 2.

In certain embodiments, the apparatus 100 comprises a gas outlet 37 arranged to enable obtaining hydrogen gas H₂ from the apparatus 100.

In certain embodiments, the apparatus 100 comprises a first passage 13 arranged to transfer a mixture comprising the water and bubbles comprising the gaseous substance from the mixing vessel 1 to the nano bubble device 2.

In certain embodiments the apparatus 100 comprises a second passage 21 arranged to transfer a mixture comprising the water and the nano bubble comprising the gaseous substance from the nano bubble device 2 to the decomposing device 3.

FIG. 3 shows one embodiment of apparatus 100 for producing hydrogen of the present invention.

In this embodiment, the mixing vessel 1 is an integral part of the nano bubble device 2.

In certain embodiments, the apparatus 100 comprises a gas outlet 37 arranged to enable obtaining hydrogen gas H2 from the apparatus 100.
the mixing vessel 1 comprises a first liquid inlet 11 arranged to receive the liquid L into the mixing vessel 1 and a second inlet 12 arranged to receive the gaseous substance G into the mixing vessel.

It should be noted that the embodiment shown in FIG. 3 may comprise features of embodiments shown in FIG. 2.

The invention has been described above with reference to the examples shown in the figures. However, the invention is in no way restricted to the above examples but may vary within the scope of the claims.

1. A method for producing hydrogen, comprising:
providing water and a gaseous substance, the gaseous substance comprising hydrogen atoms and carbon atoms,
producing a mixture comprising the water and bubbles comprising the gaseous substance,
decreasing a diameter of the bubbles comprising the gaseous substance, and
producing gaseous hydrogen by decomposing the gaseous substance in the bubbles having the decreased diameter.

2. The method according to claim 1, wherein:
the gaseous substance comprises molecules comprising hydrogen atoms and carbon atoms; or
the gaseous substance comprises molecules consisting of hydrogen atoms and carbon atoms; or
the gaseous substance consists of molecules consisting of hydrogen atoms and carbon atoms; or
the gaseous substance comprises methane; or
the gaseous substance consists of methane; or
the gaseous substance is methane.

3. The method according to claim 1, wherein:
the decreasing of the diameter of the bubbles is carried out with a nano bubble device; or
the decreasing of the diameter of the bubbles is carried out with a nano bubble device providing bubbles having a diameter less than 180 nm; or
the decreasing of the diameter of the bubbles is carried out with a nano bubble device comprising any one of the following: a pressurized dissolution device, a rotational flow device, a turbulent static mixer, an ejector nozzle and an ultrasonic device and venturi device; or
the decreasing of the diameter of the bubbles is carried out with a nano bubble device comprising any one of the following: a pressurized dissolution device, a rotational flow device, a turbulent static mixer, an ejector nozzle and an ultrasonic device or venturi device, and the nano bubble device providing bubbles having a diameter less than 180 nm.

4. The method according to claim 1, wherein:
decomposing the gaseous substance is carried out with an electrolytic cell; or
decomposing the gaseous substance to hydrogen atoms and carbon atoms, and decomposing the gaseous substance is carried out with an electrolytic cell.

5. The method according to claim 1, comprising:
decomposing a part of the water; or
decomposing a part of the water with an electrolytic cell.

6. The method according to claim 1, comprising:
obtaining hydrogen gas from the decomposing of the gaseous substance, and conducting the obtained hydrogen gas into a fuel cell, and converting the hydrogen gas into energy with the fuel cell; or
obtaining hydrogen gas from the decomposing of the gaseous substance, and conducting the obtained hydrogen gas to an engine; or
obtaining hydrogen gas from the decomposing of the gaseous substance.

7. The method according to claim 5, comprising:
obtaining oxygen from the decomposing of the part of the water and composing at least one of carbon monoxide and carbon dioxide from the carbon of the decomposed gaseous substance and oxygen obtained from the decomposed water.

8. The method according to claim 1, wherein:
in the providing of the water, the water is purified water; or
the method comprises purifying water.

9. The method according to claim 1, wherein:
the decomposing of the gaseous substance is carried out with an anode element and a cathode element, and the method comprises providing the anode element and the cathode element with electric energy; or
the decomposing of the gaseous substance is carried out with an anode element and a cathode element, and the method comprises providing the anode element and the cathode element with electric energy, and the anode element comprises platinum and the cathode element comprises stainless steel; or
the decomposing of the gaseous substance is carried out with an anode element and a cathode element, and the method comprises providing the anode element and the cathode element with electric energy, and the anode element and the cathode element comprises diamond; or
the decomposing of the gaseous substance is carried out with an anode element and a cathode element, and the method comprises providing the anode element and the cathode element with electric energy, and the anode element and the cathode element comprises black diamond; or
the decomposing of the gaseous is carried out with an anode element and a cathode element, and the method comprises providing the anode element and the cathode element with electric energy, and the anode element comprises an ion exchange film and the cathode element comprises stainless steel.

10. The method according to claim 1, wherein:
the method comprises providing a catalyst; or
the method comprises providing a catalyst, and the bubbles comprise the gaseous substance and the catalyst in the producing of the mixture; or
the method comprises providing a catalyst, and the bubbles comprise the gaseous substance and the catalyst in the producing of the mixture, and the catalyst consists of nanoparticles; or
the method comprises providing a catalyst comprising metallic nanoparticles, in the producing of the mixture the bubbles comprise the gaseous substance and the catalyst; or
the method comprises providing the gaseous substance with a catalyst comprising metallic nanoparticles; or
the method comprises providing the gaseous substance with a catalyst, the catalyst comprises metallic nanoparticles, and the providing of the gaseous substance with a catalyst is carried out before the producing of the mixture.

11. A method according to claim 1, wherein:
the method is carried out with an apparatus comprising:
a mixing vessel arranged to receive a liquid substance and a gaseous substance and arranged to produce a mixture comprising the liquid substance and bubbles comprising the gaseous substance,
a nano bubble device arranged to decrease a diameter of the bubbles comprising the gaseous substance, and
a decomposing device arranged to decompose bubbles having the decreased diameter.

12. An apparatus for producing hydrogen, comprising:
a mixing vessel arranged to receive a liquid substance and a gaseous substance and arranged to produce a mixture comprising the liquid substance and bubbles comprising the gaseous substance,
a nano bubble device arranged to decrease a diameter of the bubbles comprising the gaseous substance, and
a decomposing device arranged to decompose bubbles having the decreased diameter.

13. The apparatus according to claim 12, wherein:
the mixing vessel comprises a first liquid inlet arranged to receive the liquid into the mixing vessel and a second inlet arranged to receive the gaseous substance into the mixing vessel; or
the mixing vessel comprises a first liquid inlet arranged to receive the liquid into the mixing vessel and a second inlet arranged to receive the gaseous substance into the mixing vessel, and the mixing vessel comprises the nano bubble device.

14. The apparatus according to claim 12, wherein:
the nano bubble device comprises any one of the following: a pressurized dissolution device, a rotational flow device, a turbulent static mixer, an ejector nozzle and an ultrasonic device and a venturi device.

15. The apparatus according to claim 12, wherein the decomposing device comprises:
an anode element and a cathode element; or
an anode element and a cathode element, and the anode element comprises platinum and the cathode element comprises stainless steel; or
an anode element and a cathode element, and the anode element and the cathode element comprises diamond; or
an anode element and a cathode element, and the anode element and the cathode element comprises black diamond; or
an anode element and a cathode element, the anode element comprises an ion exchange film and the cathode element comprises stainless steel.

16. The apparatus according to claim 12, wherein:
the decomposing device is arranged to receive the mixture comprising the gaseous substance and the liquid substance from the nano bubble device.
